(19) United States
(12) Patent Application Publication
(10) Pub. No.: US 2015/0269909 A1
(43) Pub. Date: Sep. 24, 2015

(54) DISPLAY DRIVE DEVICE, DISPLAY DRIVE SYSTEM, INTEGRATED CIRCUIT DEVICE, AND DISPLAY DRIVE METHOD

(71) Applicant: SEIKO EPSON CORPORATION, Tokyo (JP)

(72) Inventor: Atsushi ISHIKAWA, Suwa-shi (JP)

(21) Appl. No.: 14/660,300

(22) Filed: Mar. 17, 2015

(30) Foreign Application Priority Data
Mar. 24, 2014 (JP) 2014-060289

(51) Int. Cl. G09G 5/12; G09G 5/18; G09G 3/36; G09G 5/00

(52) U.S. Cl. CPC G09G 5/12; G09G 5/003; G09G 5/18; G09G 3/36

(57) ABSTRACT

A display drive device, a display drive system, an integrated circuit device, and a display drive method are provided that can handle a plurality of input signals having different specifications. A display drive device 1 includes an external signal detection unit 10 that measures an external timing signal S1 and generates a detection signal S2, a processing unit 20 that generates an internal timing signal S3 based on the detection signal S2, and a drive control signal generation unit 30 that generates, based on the internal timing signal S3, a drive control signal S4 for displaying image information on a display panel 500. The processing unit 20 has a plurality of specifications, determines, based on the detection signal S2, one of the plurality of specifications to which the external timing signal S1 corresponds, and generates the internal timing signal S3 based on the corresponding specification.

### BACKGROUND

1. Technical Field

The present invention relates to a display drive device, a display drive system, an integrated circuit device, and a display drive method.

2. Related Art

A liquid crystal display (LCD) and the like are used as display devices for displaying information on electronic devices. Various proposals have also been made regarding devices for driving such display devices.

JP-A-2007-93695 discloses a display drive device that outputs white display data in place of external display data if a timing signal such as a horizontal synchronizing signal or a vertical synchronizing signal is temporarily not supplied.

JP-A-2003-167545 discloses an image display device in which the number of times that a horizontal synchronizing signal is input is counted in the period from when a vertical synchronizing signal is input until the next vertical synchronizing signal is input, and if the counted signal input number is out of a predetermined range, it is determined that the vertical synchronizing signal or the horizontal synchronizing signal is abnormal.

In JP-A-2007-93695 and JP-A-2003-167545, a use mode of accepting a plurality of input signals having different specifications is not assumed. If it is attempted to accept input signals having different specifications, it is necessary to change the setting for generating an internal timing signal, every time the specification of the input signal is changed. An image display device receives input of a setting corresponding to the change of the input signal specification from the outside, thereafter switches an input signal, and outputs a display.

### SUMMARY

The invention has been made in view of the above-described technical problem. According to some aspects of the invention, it is possible to provide a display drive device, a display drive system, an integrated circuit device, and a display drive method that can handle a plurality of input signals having different specifications.

The invention has been made in order to solve at least a part of the above-described problem, and can be realized as the following modes or application examples.

### Application Example 1

A display drive device according to this application example is a display drive device including: an external signal detection unit that measures an external timing signal and generates a detection signal; a processing unit that generates an internal timing signal based on the detection signal; and a drive control signal generation unit that generates, based on the internal timing signal, a drive control signal for displaying image information on a display panel. The processing unit has a plurality of specifications for generating the internal timing signal, determines, based on the detection signal, one of the plurality of specifications to which the external timing signal corresponds, and generates the internal timing signal based on the corresponding specification.

According to this application example, one of the plurality of specifications to which the external timing signal corresponds is determined based on the detection signal, and the internal timing signal is generated based on the corresponding specification. For this reason, it is possible to realize a display drive device that can handle a plurality of input signals including an external timing signal having a different specification.

### Application Example 2

In the above-described display drive device, the processing unit may perform the determination if the detection signal has changed.

It is thereby possible to reduce the amount of computation necessary for the determination, as compared with the case of continuously performing the determination on the detection signal.

### Application Example 3

In the above-described display drive device, the processing unit may have a storage unit that stores the plurality of specifications.

The plurality of specifications can thereby be held.

### Application Example 4

In the above-described display drive device, the external timing signal may include a vertical synchronizing signal, a horizontal synchronizing signal, an enable signal, and a dot clock signal, and the external signal detection unit may generate the detection signal by counting the vertical synchronizing signal, the horizontal synchronizing signal, and the enable signal, using the dot clock signal as a reference.

Measurement can thereby be performed with a simple circuit configuration.

### Application Example 5

In the above-described display drive device, if a part of the external timing signal does not satisfy the corresponding specification, the processing unit may generate the internal timing signal while assuming that the corresponding specification is satisfied.

With this configuration, even if a part of the external timing signal does not satisfy the corresponding specification, this is not immediately determined to be an error, and a display can be maintained.

### Application Example 6

In the above-described display drive device, the processing unit may generate the internal timing signal based on continuity of the external timing signal.

It is thereby possible to adjust a display in accordance with the external timing signal, such as to change the frame rate in the case of a moving image and in the case of a still image, for example.

### Application Example 7

A display drive system according to this application example is a display drive system including: any of the above-described display drive devices; a first display signal generation circuit that generates a first display signal including the external timing signal and display data; a second display signal generation circuit that generates a second display signal including the external timing signal and display data; and a display signal selection circuit that selects one of the first display signal and the second display signal and outputs the selected display signal to the display drive device.

According to this application example, it is possible to realize a display drive system that can handle both the first display signal and the second display signal.

### Application Example 8

An integrated circuit device according to this application example is an integrated circuit device including any of the above-described display drive devices.

According to this application example, the display drive device that can handle a plurality of input signals including an external timing signal having a different specification is included. For this reason, it is possible to realize an integrated circuit device that can handle a plurality of input signals including an external timing signal having a different specification.

### Application Example 9

A display drive method according to this application example is a display drive method including: measuring an external timing signal and generating a detection signal; generating an internal timing signal based on the detection signal; and generating, based on the internal timing signal, a drive control signal for displaying image information on a display panel. In the generating of the internal timing signal, a plurality of specifications for generating the internal timing signal are provided, one of the plurality of specifications to which the external timing signal corresponds is determined based on the detection signal, and the internal timing signal is generated based on the corresponding specification.

According to this application example, one of the plurality of specifications to which the external timing signal corresponds is determined based on the detection signal, and the internal timing signal is generated based on the corresponding specification. For this reason, it is possible to realize a display drive method that can handle a plurality of input signals including an external timing signal having a different specification.

### BRIEF DESCRIPTION OF THE DRAWINGS

FIG. 1 is a circuit diagram of an integrated circuit device 1000 according to the present embodiment.

FIG. 2 is a flowchart showing an outline of a display drive method according to the present embodiment.

FIGS. 3A to 3D are timing charts showing exemplary operations of a display drive device 1 according to the present embodiment.

FIGS. 4A to 4D are timing charts showing other exemplary operations of the display drive device 1 according to the present embodiment.

FIG. 5 is a circuit diagram of an integrated circuit device 1000a according to a modification of the present embodiment.

### DESCRIPTION OF EXEMPLARY EMBODIMENTS

Hereinafter, a preferable embodiment of the invention will be described in detail using the drawings. The used drawings are for convenience of the description. Note that the embodiment described below is not intended to unjustly limit the content of the invention described in the scope of claims. Not all configurations described below necessarily are essential constituent elements of the invention.

1. Display Drive Device and Integrated Circuit Device

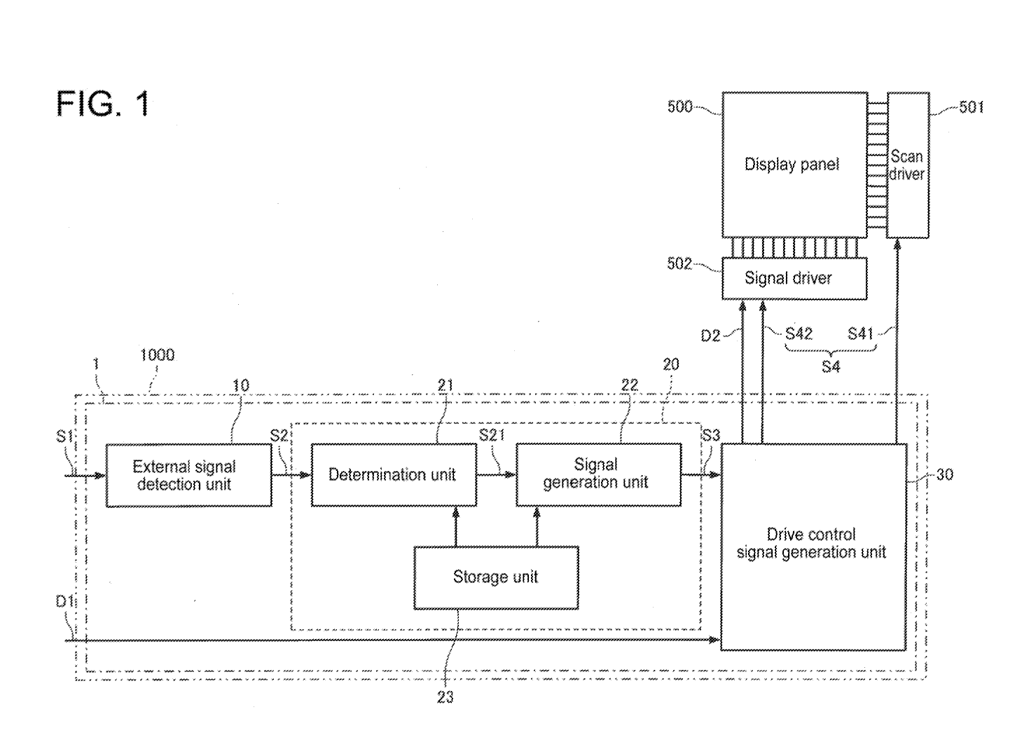

FIG. 1 is a circuit diagram of an integrated circuit device 1000 according to the present embodiment. The integrated circuit device 1000 according to the present embodiment is configured to include a display drive device 1. In the present embodiment, a display panel 500 is a liquid crystal display device. Note that, as the display panel 500, various known display panels, such as an organic electroluminescent display device and an electrophoretic display device, may be employed.

The display drive device 1 according to the present embodiment is configured to include an external signal detection unit 10, a processing unit 20, and a drive control signal generation unit 30.

The external signal detection unit 10 measures an external timing signal S1 and generates a detection signal S2. The external timing signal S1 may include a vertical synchronizing signal, a horizontal synchronizing signal, an enable signal, and a dot clock signal, for example. The external signal detection unit 10 may measure the external timing signal S1 and generate the detection signal S2 based on a measurement result, by counting the vertical synchronizing signal, the horizontal synchronizing signal, and the enable signal, using the dot clock signal as a reference.

The processing unit 20 generates an internal timing signal S3 based on the detection signal S2. The processing unit 20 has a plurality of specifications for generating the internal timing signal S3, determines, based on the detection signal S2, one of the plurality of specifications to which the external timing signal S1 corresponds, and generates the internal timing signal S3 based on the corresponding specification. If the external timing signal S1 corresponds to none of the plurality of specifications, the processing unit 20 may generate and output an internal timing signal S3 for an error display (e.g., full-screen white display or full-screen black display). The processing unit 20 may continuously perform the determination regarding the detection signal S2, and stop the output of the error display if the error in the determination regarding the detection signal S2 is resolved. In this case, the processing unit 20 is restored to a state of outputting the internal timing signal S3 based on the corresponding specification.

In the example shown in FIG. 1, the processing unit 20 is configured to include a determination unit 21, a signal generation unit 22, and a storage unit 23.

The determination unit 21 references information regarding the specifications (specifications for generating the internal timing signal S3) stored in the storage unit 23, determines, based on the detection signal S2, one of the plurality of specifications to which the external timing signal S1 corresponds, and outputs information regarding a determination result to the signal generation unit 22 via a signal S21.

The signal generation unit 22 references the information regarding the specifications (specifications for generating the internal timing signal S3) stored in the storage unit 23, and generates the internal timing signal S3 based on the result of the determination performed by the determination unit 21.

The storage unit 23 stores the information regarding the specifications for generating the internal timing signal S3. The storage unit 23 stores the information regarding the plurality of specifications (specifications for generating the internal timing signal S3). The storage unit 23 may be constituted by a nonvolatile memory, for example.

The drive control signal generation unit 30 generates a drive control signal S4 for displaying image information on the display panel 500, based on the internal timing signal S3. In the example shown in FIG. 1, the drive control signal generation unit 30 outputs, as the drive control signal S4, the signal S41 and a signal S42 respectively to a scan driver 501 that controls the display panel 500 and a signal driver 502 that controls the display panel 500. Also, in the example shown in FIG. 1, the drive control signal generation unit 30 accepts input of display data D1 corresponding to the external timing signal S1, converts the input into display data D2 corresponding to the drive control signal S4, and outputs it to the signal driver 502.

Note that a specific example of operations of the display drive device 1 according to the present embodiment will be described later in the section of “2. Exemplary operations of display drive device and display drive method”.

With the display drive device 1 according to the present embodiment, one of the plurality of specifications to which the external timing signal S1 corresponds is determined based on the detection signal S2, and the internal timing signal S3 is generated based on the corresponding specification. For this reason, it is possible to realize the display drive device 1 that can handle input signals including an external timing signal having a different specification. For example, if the display drive device 1 receives an input signal having a second specification during a display output operation based on an input signal having a first specification, the display drive device 1 can automatically select a setting for generating the internal timing signal S3 and output a display corresponding to the input signal having the second specification.

In the display drive device 1 according to the present embodiment, the processing unit 20 may perform the determination if the detection signal S2 has changed. In this case, for example, the external signal detection unit 10 may output, as the detection signal S2, a change flag indicating whether or not the external timing signal S1 has changed, to the processing unit 20. It is thereby possible to reduce the amount of computation necessary for the determination, as compared with the case of continuously performing the determination on the detection signal S2.

In the display drive device 1 according to the present embodiment, if the processing unit 20 determines, based on the detection signal S2, whether or not the external timing signal S1 satisfies any of the plurality of specifications, and a part of the external timing signal S1 does not satisfy the corresponding specification, the processing unit 20 may assume that the corresponding specification is satisfied and generate the internal timing signal S3. The processing unit 20 determines whether the external timing signal S1 is allowable with respect to the corresponding specification. For example, a configuration may be employed in which an allowable range is provided with respect to the corresponding specification. If the signal is allowable with respect to the corresponding specification, the internal timing signal S3 may be generated based on the corresponding specification. In the example shown in FIG. 1, the determination unit 21 may determine, based on the detection signal S2, whether or not the external timing signal S1 satisfies any of the plurality of specifications.

For example, in the case of a minor error, as in the case where only a porch period of the external timing signal S1 does not satisfy the specification, there are cases where it is favorable to continue a display without switching the display to an error display. According to the present embodiment, even if a part of the external timing signal S1 does not satisfy the specification, this is not immediately determined to be an error, and the display can be continued.

In the display drive device 1 according to the present embodiment, the processing unit 20 may determine continuity of the external timing signal S1, based on the detection signal S2, and generate the internal timing signal S3 based on the continuity of the external timing signal S1. In the example shown in FIG. 1, the determination unit 21 may determine the continuity of the external timing signal S1, based on the detection signal S2. By performing this determination, it is possible to adjust the display in accordance with the external timing signal S1, such as to change the frame rate in the case of a moving image and in the case of a still image. For example, control for increasing the frame rate is performed if an input signal is changed so as to display a moving image, and control for decreasing the frame rate is performed if an input signal is changed so as to display a still image.

The integrated circuit device 1000 according to the present embodiment is configured to include the display drive device 1 that can handle a plurality of input signals including the external timing signal S1 having a different specification. For this reason, it is possible to realize the integrated circuit device 1000 that can handle a plurality of input signals including the external timing signal S1 having a different specification.

2. Exemplary Operations of Display Drive Device and Display Drive Method

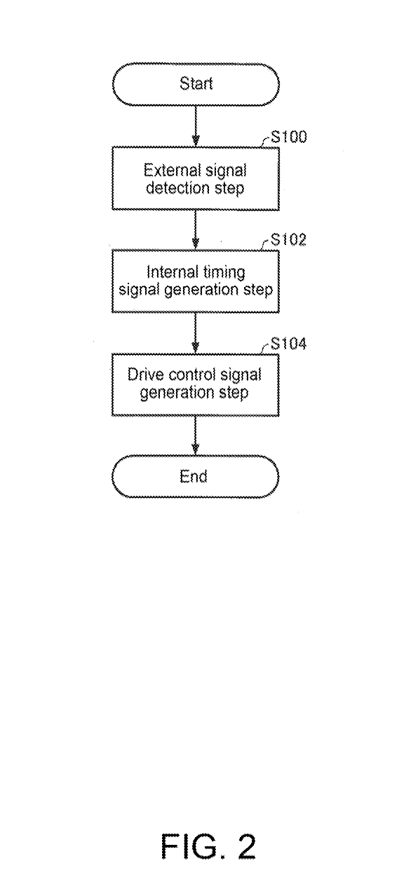

FIG. 2 is a flowchart showing an outline of the display drive method according to the present embodiment. An example of realizing the method using the above-described display drive device 1 will be described below.

The display drive method according to the present embodiment includes an external signal detection step (step S100) of measuring the external timing signal S1 and generating the detection signal S2, an internal timing signal generation step (step S102) of generating the internal timing signal S3 based on the detection signal S2, and a drive control signal generation step (step S104) of generating, based on the internal timing signal S3, the drive control signal S4 for displaying image information on the display panel 500.

In the present embodiment, the step in which the external signal detection unit 10 in the display drive device 1 measures the external timing signal S1 and generates the detection signal S2 corresponds to the external signal detection step in step S100.

In the present embodiment, the step in which the processing unit 20 in the display drive device 1 generates the internal timing signal S3 based on the detection signal S2 corresponds to the internal timing signal generation step in step S102. In the internal timing signal generation step (step S102), the processing unit 20 has a plurality of specifications for generating the internal timing signal S3, determines, based on the detection signal S2, one of the plurality of specifications to which the external timing signal S1 corresponds, and generates the internal timing signal S3 based on the corresponding specification.

In the present embodiment, the step in which the drive control signal generation unit 30 in the display drive device 1 generates, based on the internal timing signal S3, the drive control signal S4 for displaying image information on the display panel 500 corresponds to the drive control signal generation step in step S104.

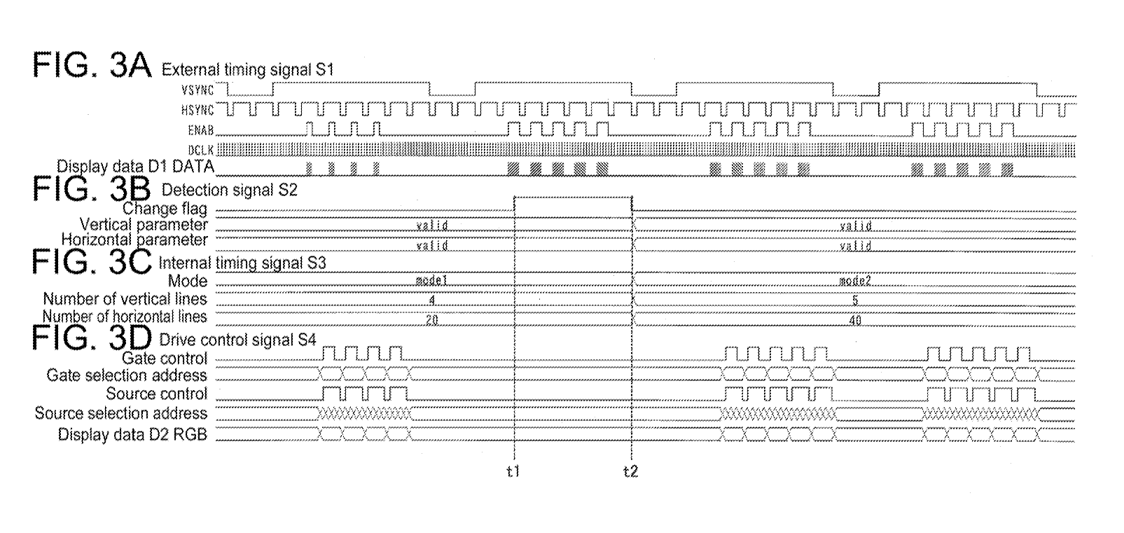

FIGS. 3A to 3D are timing charts showing exemplary operations of the display drive device 1 according to the present embodiment. In the example shown in FIGS. 3A to 3D, the number of vertical lines and the number of horizontal lines change.

In FIG. 3A, a vertical synchronizing signal VSYNC, a horizontal synchronizing signal HSYNC, an enable signal ENAB, and a dot clock signal DCLK are shown as the external timing signal S1, and display data DATA is shown as the display data D1. In FIG. 3B, the change flag, a vertical parameter, and a horizontal parameter are shown as the detection signal S2. In FIG. 3C, a mode, the number of vertical lines, and the number of horizontal lines are shown as the internal timing signal S3. In FIG. 3D, a gate control signal and a gate selection address signal are shown as the signal S41 in the drive control signal S4, a source control signal and a source selection address signal are shown as the signal S42, and RGB data is shown as the display data D2.

In the example shown in FIGS. 3A to 3D, the external signal detection unit 10 detects that the width of the enable signal ENAB expands at time t1 in a second frame, changes the change flag from a low level to a high level, and outputs it. The enable signal ENAB becomes high four times in a first frame, whereas the enable signal ENAB becomes high five times in the second frame and subsequent frames.

At time t2 in the second frame, the processing unit 20 changes the operation mode from a first mode mode1 in which the number of vertical lines is 4 and the number of horizontal lines is 20 to a second mode mode2 in which the number of vertical lines is 5 and the number of horizontal lines is 40.

Before and at time t2 in the second frame, the drive control signal generation unit 30 generates the drive control signal S4 based on the internal timing signal S3 generated by the processing unit 20 whose operation mode is the first mode mode1. After time t2 in the second frame, the drive control signal generation unit 30 generates the drive control signal S4 based on the internal timing signal S3 generated by the processing unit 20 whose operation mode is the second mode mode2.

By thus changing the operation mode in accordance with the external timing signal S1 and generating the internal timing signal S3, it is possible to handle a plurality of input signals including the external timing signal S1 having a different specification.

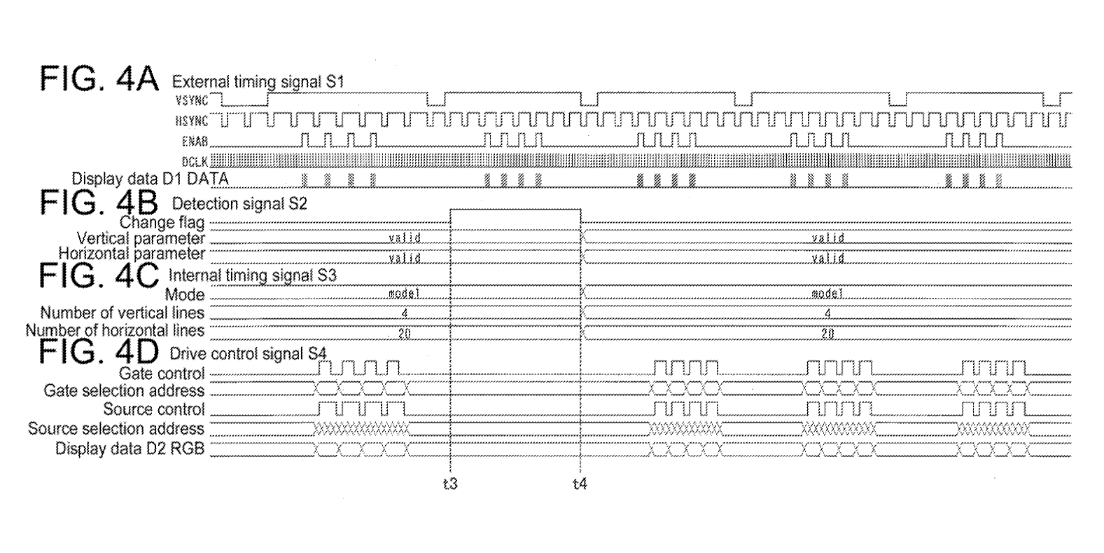

FIGS. 4A to 4D are timing charts showing other exemplary operations of the display drive device 1 according to the present embodiment. In the example shown in FIGS. 4A to 4D, a vertical porch period and a horizontal porch period change.

In FIG. 4A, a vertical synchronizing signal VSYNC, a horizontal synchronizing signal HSYNC, an enable signal ENAB, and a dot clock signal DCLK are shown as the external timing signal S1, and display data DATA is shown as the display data D1. In FIG. 4B, the change flag, a vertical parameter, and a horizontal parameter are shown as the detection signal S2. In FIG. 4C, a mode, the number of vertical lines, and the number of horizontal lines are shown as the internal timing signal S3. In FIG. 4D, a gate control signal and a gate selection address signal are shown as the signal S41 in the drive control signal S4, a source control signal and a source selection address signal are shown as the signal S42, and RGB data is shown as the display data D2.

In the example shown in FIGS. 4A to 4D, the external signal detection unit 10 detects that the widths of the vertical synchronizing signal VSYNC and the horizontal synchronizing signal HSYNC narrow at time t3 in a second frame, changes the change flag from a low level to a high level, and outputs it.

At time t4 in the second frame, the processing unit 20 remains in the first mode mode1 in which the number of vertical lines is 4 and the number of horizontal lines is 20, and generates the internal timing signal S3 while changing the timing thereof.

Before and at time t4 in the second frame, the drive control signal generation unit 30 generates the drive control signal S4 based on the internal timing signal S3 generated by the processing unit 20 before the timing is changed. After time t4 in the second frame, the drive control signal generation unit 30 generates the drive control signal S4 based on the internal timing signal S3 generated by the processing unit 20 after the timing is changed.

Thus, if only a porch period has changed, this is not immediately determined to be an error, and the internal timing signal S3 can be adjusted to continue the display.

Note that, although pipeline processing for each frame is not performed in the above-described exemplary operations, pipeline processing for each frame may be performed.

With the display drive method according to the present embodiment, one of the plurality of specifications to which the external timing signal S1 corresponds is determined based on the detection signal S2, and the internal timing signal S3 is generated based on the corresponding specification. For this reason, it is possible to realize a display drive method that can handle input signals including the external timing signal S1 having a different specification.

3. Display Drive System

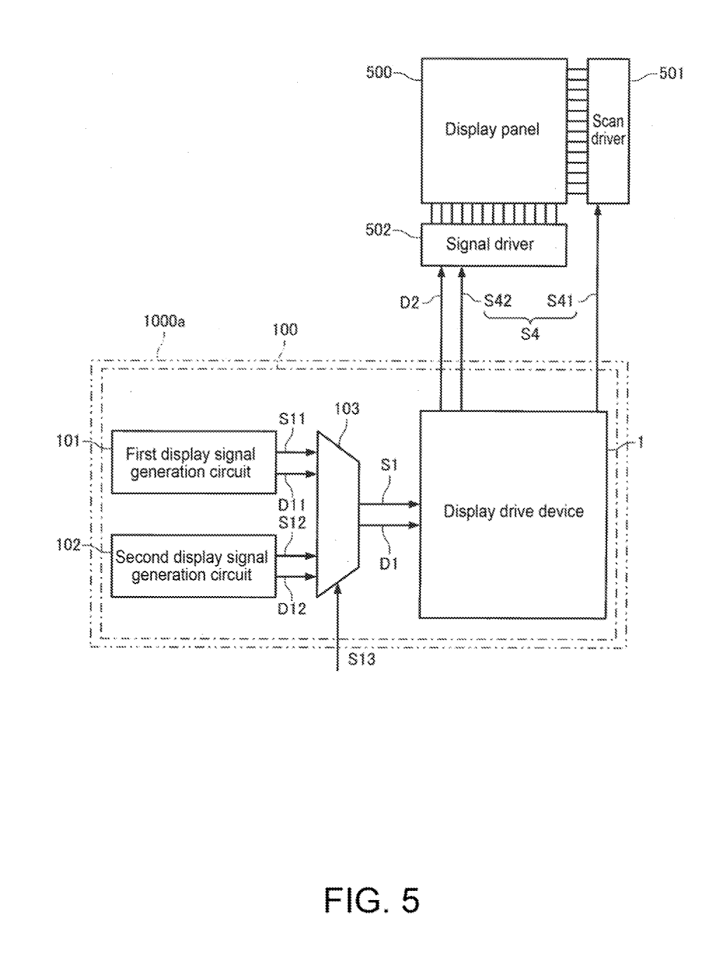

FIG. 5 is a circuit diagram of an integrated circuit device 1000a according to a modification of the present embodiment. The integrated circuit device 1000a according to the modification is configured to include a display drive system 100 including the display drive device 1. Note that configurations similar to those in the above embodiment are given the same reference numerals, and a detailed description thereof will be omitted.

The display drive system 100 according to the modification is configured to include the display drive device 1, a first display signal generation circuit 101, a second display signal generation circuit 102, and a display signal selection circuit 103.

The first display signal generation circuit 101 generates a first display signal including an external timing signal S11 and display data D11.

The second display signal generation circuit 101 generates a second display signal including an external timing signal S12 and display data D12.

The display signal selection circuit 103 selects one of the first display signal (external timing signal S11 and display data D11) and the second display signal (external timing signal S12 and display data D12), and outputs the selected signal as the external timing signal S1 and the display data D1 to the display drive device 1. The display signal selection circuit 103 may determine a display signal to be selected, based on a selection control signal S13.

With the display drive system 100 according to the modification, it is possible to realize the display drive system 100 that can handle both the first display signal (external timing signal S11 and display data D11) and the second display signal (external timing signal S12 and display data D12).

Furthermore, since the display drive system 100 according to the modification is configured to include the display drive device 1, it achieves a similar effect for reasons similar to the reasons described in the section of “1. Display drive device and integrated circuit device” and the section of “2. Exemplary operations of display drive device and display drive method”.

Although the embodiment and the modification have been described above, the invention is not limited to these embodiment and the modification, and can be carried out in various modes without departing from the gist of the invention.

The invention includes substantially the same configurations (e.g., configurations with the same functions, methods, and results, or configurations with the same object and effect) as the configurations described in the embodiment. The invention includes configurations in which an unessential part of the configurations described in the embodiment is replaced. The invention also includes configurations that achieve the same effect as that of the configurations described in the embodiment, or configurations that can achieve the same object as that of the configurations described in the embodiment. The invention also includes configurations obtained by adding a known technique to the configurations described in the embodiment.

The entire disclosure of Japanese Patent Application No. 2014-060289, filed Mar. 24, 2014 is expressly incorporated by reference herein.

What is claimed is:

1. A display drive device comprising:
an external signal detection unit that measures an external timing signal and generates a detection signal;
a processing unit that generates an internal timing signal based on the detection signal; and
a drive control signal generation unit that generates, based on the internal timing signal, a drive control signal for displaying image information on a display panel,
wherein the processing unit has a plurality of specifications for generating the internal timing signal, determines, based on the detection signal, one of the plurality of specifications to which the external timing signal corresponds, and generates the internal timing signal based on the corresponding specification.

2. The display drive device according to claim 1,
wherein the processing unit performs the determination if the detection signal has changed.

3. The display drive device according to claim 1,
wherein the processing unit has a storage unit that stores the plurality of specifications.

4. The display drive device according to claim 1,
wherein the external timing signal includes a vertical synchronizing signal, a horizontal synchronizing signal, an enable signal, and a dot clock signal, and
the external signal detection unit generates the detection signal by counting the vertical synchronizing signal, the horizontal synchronizing signal, and the enable signal, using the dot clock signal as a reference.

5. The display drive device according to claim 1,
wherein, if a part of the external timing signal does not satisfy the corresponding specification, the processing unit generates the internal timing signal while assuming that the corresponding specification is satisfied.

6. The display drive device according to claim 1,
wherein the processing unit generates the internal timing signal based on continuity of the external timing signal.

7. A display drive system comprising:
the display drive device according to claim 1;
a first display signal generation circuit that generates a first display signal including the external timing signal and display data;
a second display signal generation circuit that generates a second display signal including the external timing signal and display data; and
a display signal selection circuit that selects one of the first display signal and the second display signal and outputs the selected display signal to the display drive device.

8. An integrated circuit device comprising the display drive device according to claim 1.

9. A display drive method comprising:
measuring an external timing signal and generating a detection signal;
generating an internal timing signal based on the detection signal; and
generating, based on the internal timing signal, a drive control signal for displaying image information on a display panel,
wherein, in the generating of the internal timing signal, a plurality of specifications for generating the internal timing signal are provided, one of the plurality of specifications to which the external timing signal corresponds is determined based on the detection signal, and the internal timing signal is generated based on the corresponding specification.
